(19) United States
(12) Patent Application Publication
(10) Pub. No.: US 2008/0255406 A1
(43) Pub. Date: Oct. 16, 2008

(54) Implantable Auditory Stimulation Systems Having a Transducer and a Transduction Medium

(75) Inventors: Geoffrey R. Ball, Axams (AT); Peter Lampacher, Innsbruck (AT)

Correspondence Address: Casimir Jones, S.C., 440 Science Drive, Suite 203, Madison, WI, 53711, US

(73) Assignee: VIBRANT MED-EL HEARING TECHNOLOGY GMBH, Innsbruck (AT)

(21) Appl. No.: 12/059,214

(22) Filed: Mar. 31, 2008

Related U.S. Application Data
(60) Provisional application No. 60/921,009, filed on Mar. 29, 2007.

(51) Int. Cl. H04R 25/00

(52) U.S. Cl. 600/25

(57) ABSTRACT

Systems and methods for improving sound perception in a subject equipped with an implantable vibratory unit comprising a transducer and a transduction medium in which the transducer is disposed within or against the transduction medium. The transducer is configured to impart vibrations to a vibratory structure of a subject's ear through the transduction medium in response to an electrical signal corresponding to sound. In certain embodiments, the transduction medium directly contacts the vibratory structure of the subject's ear, whereas the transducer does not.

The present application claims priority to U.S. Provisional Application Ser. No. 60/60/921,009, filed Mar. 29, 2007, which is herein incorporated by reference.

### FIELD OF THE INVENTION

The present invention relates to implantable auditory stimulation systems for imparting vibrations to an inner ear of a hearing impaired subject. In particular, the present invention provides methods, systems, and devices for coupling a transducer to a vibratory structure of an ear via a transduction medium.

### BACKGROUND OF THE INVENTION

The seemingly simple act of hearing is a something that can easily be taken for granted. The hearing mechanism is a system of levers, membranes, fluid reservoirs, neurons and hair cells that must work together in order to deliver nervous stimuli to the brain where this information is compiled into the higher level perception known as sound. As the human hearing system encompasses complex acoustic, mechanical and neurological systems, its function can be compromised by hereditary disorders or physical trauma. Unfortunately hearing impairment is not a rare condition. It is estimated that one out of every ten people suffer some form of hearing loss.

Various types of hearing aids have been developed to restore or improve hearing for the hearing impaired. With conventional hearing aids, sound is detected by a microphone, amplified using amplification circuitry, and transmitted in the form of acoustical energy by a speaker or another type of transducer into the middle ear by way of the tympanic membrane. Often the acoustical energy delivered by the speaker is detected by the microphone, which causes a high-pitched feedback whistle. Moreover, the amplified sound produced by conventional hearing aids normally includes a significant amount of distortion. Thus, it is not surprising that many patients who suffer from hearing loss do not seek treatment for this condition despite the fact that success in professional and social situations is becoming more dependent on effective hearing.

Attempts have been made to eliminate the feedback and distortion problems associated with conventional hearing aid systems. These attempts have yielded devices that convert sound waves into electromagnetic fields having the same frequencies as the sound waves. A microphone detects the sound waves, which are both amplified and converted into an electrical current. A coil winding is held stationary by being attached to a non-vibrating structure within the middle ear. The current is delivered to the coil to generate an electromagnetic field. A separate magnet is attached to an ossicle within the middle ear so that the magnetic field of the magnet interacts with the magnetic field of the coil. The magnet vibrates in response to the interaction of the magnetic fields, causing vibration of the bones of the middle ear.

Existing electromagnetic transducers present several problems. Many are installed using complex surgical procedures presenting the usual risks associated with major surgery and require disarticulating (disconnecting) one or more of the bones of the middle ear. Disarticulation deprives the patient of any residual hearing he or she may have had prior to surgery, placing the patient in a worsened position if the implanted device is later found to be ineffective in improving the patient's hearing.

Thus, there remains a need in the art for improved vibratory stimulation systems that can be implanted using less complex surgical techniques, yet are less prone to translocation and do not require disarticulation of the ossicular chain if present.

### SUMMARY OF THE INVENTION

The present invention relates to implantable auditory stimulation systems for imparting vibrations to an inner ear of a hearing impaired subject. In particular, the present invention provides methods, systems, and devices for coupling a transducer to a vibratory structure of an ear via a transduction medium.

In particular, the present invention provides fully implantable vibratory units comprising a transducer and a transduction medium, wherein the transducer is configured to be positioned within or against the transduction medium. The transducer is further configured to impart vibrations to a vibratory structure of a subject's ear through the transduction medium in response to an electrical signal corresponding to sound. In some embodiments, the transducer is coated with the transduction medium. In some preferred embodiments, the transducer does not directly contact a vibratory structure of the subject's ear. In some preferred embodiments, the transduction medium directly contacts a vibratory structure of the subject's ear. In some preferred embodiments, the vibratory structure comprises one or both of a round window and an oval window.

The present invention also provides systems comprising: a transduction medium configured to be positioned within a middle ear of a subject; and a transducer configured to be positioned within, or against the transduction medium such that vibrations from the transducer are able to pass through the transduction medium to vibrate an inner ear of the subject. In some embodiments, the systems further comprise a packaging component, wherein the transduction medium and the transducer are both located inside the packaging component (e.g., sterile packaging). In some preferred embodiments, the transduction medium has a volume of between 0.5 microliters and 500 microliters, preferably between 5 microliters and 50 microliters, preferably about 25 microliters. In some embodiments, the transducer does not directly contact a vibratory structure of the subject's ear. In some embodiments, the transduction medium directly contacts a vibratory structure of the subject's ear. In some preferred embodiments, the vibratory structure comprises one or both of a round window and an oval window. In some embodiments, the transducer is an electromagnetic transducer, which in preferred embodiments is a floating mass transducer. In other embodiments, the transducer is a piezoelectric transducer. In some preferred embodiments, the transducer comprises a permanent magnet and a coil. In some embodiments, the transduction medium comprises a liquid or semi-solid aqueous composition. In some embodiments, the transduction medium comprises a silicon elastomer configured to be interposed between the transducer and a vibratory structure of the subject's ear. In some embodiments, the transduction medium comprises a collagenous material configured to be interposed between the transducer means and a vibratory structure of the subject's ear. In some embodiments, the transduction medium comprises a biocompatible material configured to be interposed between the transducer means and a vibratory structure of the subject's ear and to encourage tissue encapsulation upon implantation. In some preferred embodiments, the biocompatible material comprises one or more of the group consisting of but not limited to hydroxyapatite, titanium, ceravitol, TEFLON and GORE-TEX. In some preferred embodiments, the biocompatible material is shaped to cover a round window or an oval window of the subject's ear. In some embodiments, the transducer is wholly disposed within the transduction medium, while in other embodiments, the transducer is against the transduction medium. In some embodiments, the transduction medium is cylindrical having a distal end configured to contact a round window or an oval window of the subject's ear and a proximal end configured to contact the transducer. In some preferred embodiments, the transduction medium is a disc having a diameter of less than about 4.5 mm, preferably less than 3.5 mm, more preferably less than 2.5 mm and a depth of less than about 2.5 mm, preferably less than 1.5 mm, more preferably less than 0.5 mm. In some preferred embodiments, the transduction medium has a diameter in the range of 0.5 to 4.5 mm, preferably 1.0 to 4.0 mm, more preferably 1.5 to 3.5 mm, most preferably 1.0 to 2.0 mm; and a depth in the range of 0.25 to 2.5 mm, preferably 0.5 to 2.0 mm, more preferably 0.75 to 1.5 mm (e.g., about 1.0 mm). In some embodiments, the systems further comprise a receiver unit for conducting an electrical signal produced in response to sound, to the transducer. In some embodiments, the receiver unit is an implantable receiver unit configured to be placed at a subcutaneous position behind the subject's ear. In some embodiments, the implantable receiver unit comprises a receiver coil and a magnet, disposed within and attached to a housing. In some embodiments, the implantable receiver unit is connected to the transducer with a lead of less than 15 mm in length. In some preferred embodiments, the lead is suitable for damping vibration from the transducer to the receiver unit. In some embodiments, the systems further comprise an external audio processor unit suitable for converting sound into an electric signal. In some embodiments, the external audio processor unit is configured to be magnetically affixed to skin of the subject in a position above the implantable receiver unit. In some embodiments, the external audio processor unit comprises an attachment magnet, a microphone, a battery, and a coil, disposed within and attached to a housing. In some embodiments, the external audio processor unit is configured to be attached to a pair of glasses worn by the subject in a position above the implantable receiver unit. In some embodiments, the external audio processor unit does not comprise a magnet.

Additionally the present invention provides systems comprising: an audio processor unit; a receiver unit; and an implantable vibratory unit comprising a transducer and transduction medium. In some embodiments, the transducer is configured to be position within or against the transduction medium to impart vibrations to a vibratory structure of a subject's ear through the transduction medium in response to an electrical signal corresponding to sound. In some embodiments, the audio processor unit is an external unit and the receiver unit is an implantable unit. In other embodiments, the audio processor unit and the receiver unit are implantable. In some embodiments, the transduction medium is a housing for the transducer.

Moreover the present invention provides methods comprising: providing an implantable vibratory unit comprising an electromagnetic transducer and a transduction medium; and surgically implanting the vibratory unit in a middle ear of a subject by positioning the transduction medium in contact with a vibratory structure of the subject's ear and the transducer within or against the transduction medium such that vibrations from the transducer are transmitted through the transduction medium to an inner ear of the subject. In some embodiments, the transducer does not directly contact a vibratory structure of the subject's ear. In some embodiments, the transduction medium directly contacts a vibratory structure of the subject's ear. In some preferred embodiments, the vibratory structure comprises one or both of a round window and an oval window. In some preferred embodiments, the methods further comprise coupling the transducer to a microphone that produces an electrical signal in response to ambient sound.

The present invention also provides methods for enhancing hearing by artificially vibrating a cochlea of a subject, comprising: placing a vibratory unit comprising a transducer and transduction medium in a middle ear of the subject such that the transducer is positioned within or against the transduction medium; vibrating the cochlea of the subject by imparting vibrations from the transducer through the transduction medium in response to an electrical signal corresponding to sound. In some embodiments, the transduction medium but not the transducer directly contacts a vibratory structure of the subject's ear. In some embodiments, a transmitter communicates the electrical signal to the transducer, and both the transmitter and the transducer are in contact within a common transduction medium. In some embodiments, both the transmitter and the transducer are encapsulated in the transduction medium. In some embodiments, the transduction medium comprises one or more of the group consisting of but not limited to a silicon elastomer, collagen, liquid silicone and water. In some preferred embodiments, the vibratory structure comprises one or both of a round window and an oval window. In some embodiments, the transducer is selected from the group consisting of but not limited to a linear actuator type transducer, a rotational type transducer, a torqueing type transducer, a diaphragm type transducer and a speaker/driver type transducer. In other embodiments, the transducer is selected from the group consisting of but not limited to a piston/plunger type transducer, a unidirectional type transducer, a bidirectional type transducer and a multi-directional type transducer.

### BRIEF DESCRIPTION OF THE DRAWINGS

FIG. 1A provides a schematic of an exemplary vibrational transducer disposed within a transduction medium in contact with a vibratory structure of an ear (e.g., round window, oval window, ossicular chain, etc.) for artificially vibrating the cochlear fluid in response to sound. As shown in FIG. 1B, in some embodiments, the vibrational transducer is an inertial drive floating mass transducer (e.g., Vibrant Med El FMT).

FIG. 2 illustrates the placement of a vibrational transducer disposed within a transduction medium in contact with a round window. In this subject, the ear canal, ossicular chain, tympanic membrane and oval window are all intact. The present devices however, are also suitable for use by subjects lacking a functional tympanic membrane and/or ossicular chain (e.g., missing or fixed stapes).

FIG. 3 illustrates the placement of a plunger drive type transducer and associated armature in which the distal end of the transducer is positioned in contact with a transduction medium. In this embodiment, the transducer armature is mounted to a mastoid bone.

### DEFINITIONS

As used herein, the term “subject” refers to a human or other animal. It is intended that the term encompass patients, such as hearing impaired patients.

The terms “hearing impaired subject” and “hearing impaired patient” refer to animals or persons with any degree of loss of hearing that has an impact on the activities of daily living or that requires special assistance or intervention. In preferred embodiments, the term hearing-impaired subject refers to a subject with conductive or mixed hearing loss.

As used herein, the terms “external ear canal” and “external auditory meatus” refer to the opening in the skull through which sound reaches the middle ear. The external ear canal extends to the tympanic membrane (or “eardrum”), although the tympanic membrane itself is considered part of the middle ear. The external ear canal is lined with skin, and due to its resonant characteristics, provides some amplification of sound traveling through the canal. The “outer ear” includes those parts of the ear that are normally visible (e.g., the auricle or pinna, and the surface portions of the external ear canal).

As used herein, the term “middle ear” refers to the portion of the auditory system that is internal to the tympanic membrane, and including the tympanic membrane, itself. It includes the auditory ossicles (i.e., malleus, incus, and stapes, commonly known as the hammer, anvil, and stirrup) that from a bony chain (e.g., ossicular chain) across the middle ear chamber to conduct and amplify sound waves from the tympanic membrane to the oval window. The ossicles are secured to the walls of the chamber by ligaments. The middle ear is open to the outside environment by means of the eustachian tube.

As used herein, the term “inner ear” refers to the fluid-filled portion of the ear. Sound waves relayed by the ossicles to the oval window are created in the fluid, pass through the cochlea to stimulate the delicate hair-like endings of the receptor cells of the auditory nerve. These receptors generate electrochemical signals that are interpreted by the brain as sound.

As used herein, the term “vibratory structure of an ear” refers to the tympanic membrane, ossicles, oval window and round window.

The term “cochlea” refers to the part of the inner ear that is concerned with hearing. The cochlea is a division of the bony labyrinth located anterior to the vestibule, coiled into the form of a snail shell, and having a spiral canal in the petrous part of the temporal bone.

The term “cochlear hair cell” refers to the sound sensing cell of the inner ear, which have modified ciliary structures (e.g., hairs), that enable them to produce an electrical (neural) response to mechanical motion caused by the effect of sound waves on the cochlea. Frequency is detected by the position of the cell in the cochlea and amplitude by the magnitude of the disturbance.

The term “cochlear fluid” refers to the liquid within the cochlea that transmits vibrations to the hair cells.

The terms “round window” and “fenestra of the cochlea” refer to an opening in the medial wall of the middle ear leading into the cochlea.

The term “temporal bone” refers to a large irregular bone situated in the base and side of the skull, including the, squamous, tympanic and petrous. The term “mastoid process” refers to the projection of the temporal bone behind the ear.

As used herein, the terms “power source” and “power supply” refer to any source (e.g., battery) of electrical power in a form that is suitable for operating electronic circuits. Alternating current power may be derived either directly or by means of a suitable transformer. “Alternating current” refers to an electric current whose direction in the circuit is periodically reversed with a frequency f that is independent of the circuit constants. Direct current power may be supplied from various sources, including, but not limited to batteries, suitable rectifier/filter circuits, or from a converter. “Direct current” refers to a unidirectional current of substantially constant value. The term also encompasses embodiments that include a “bus” to supply power to several circuits or to several different points in one circuit. A “power pack” is used in reference to a device that converts power from an alternating current or direct current supply, into a form that is suitable for operating electronic device(s). As used herein, the term “battery” refers to a cell that furnishes electric current to the hearing devices of the present invention. In some embodiments of the present invention, “rechargeable” batteries are used.

As used herein, the term “microphone” refers to a device that converts sound energy into electrical energy. It is the converse of the loudspeaker, although in some devices, the speaker-microphone may be used for both purposes (i.e., a loudspeaker microphone). Examples of microphones include, but are not limited to, carbon, capacitor, crystal, moving-coil, and ribbon embodiments. Most microphones operate by converting sound waves into mechanical vibrations that then produce electrical energy. The force exerted by the sound is usually proportional to the sound pressure. In some embodiments, a thin diaphragm is mechanically coupled to a suitable device (e.g., a coil). In alternative embodiments, the sound pressure is converted to electrical pressure by direct deformation of suitable magnetorestrictive or piezoelectric crystals (e.g., magnetorestriction and crystal microphones).

As used herein, the term “amplifier” refers to a device that produces an electrical output that is a function of the corresponding electrical input parameter, and increases the magnitude of the input by means of energy drawn from an external source (i.e., it introduces gain). “Amplification” refers to the reproduction of an electrical signal by an electronic device, usually at an increased intensity.

As used herein, the term “transmitter” refers to a device, circuit, or apparatus of a system that is used to transmit an electrical signal to the receiving part of the system. A “transmitter coil” is a device that receives an electrical signal and broadcasts it to a “receiver coil.” It is intended that transmitter and receiver coils may be used in conjunction with centering magnets, which function to maintain the placement of the coils in a particular position and/or location.

As used herein, the term “receiver” refers to the part of a system that converts transmitted waves into a desired form of output. The range of frequencies over which a receiver operates with a selected performance (i.e., a known level of sensitivity) is the “bandwidth” of the receiver. The “minimal discernible signal” is the smallest value of input power that results in output by the receiver.

As used herein, the term “transducer” refers to any device that converts a non-electrical parameter (e.g., sound, pressure or light), into electrical signals or vice versa. Microphones are one type of electroacoustic transducer.

As used herein, the terms “floating mass transducer” and “FMT,” refer to a transducer with a mass that vibrates in direct response to an external signal corresponding to sound waves (See, e.g., U.S. Pat. Nos. 5,456,654, 5,554,096, 5,624,376 and 5,913,815, herein incorporated by reference in their entirety). The mass is coupled to a housing (e.g., mechanically coupled or otherwise linked), which in preferred embodiments is disposed within a transduction medium or integration structure placed adjacent to a vibratory structure of a subject's ear. Thus, the mechanical vibration of the floating mass is transformed into a vibration of vibratory structure of the ear allowing the subject to perceive sound.

Another electromagnetic vibrator for use with the devices and methods of the present invention is a balanced electromagnetic separation transducer as described in U.S. Pat. No. 6,751,334, herein incorporated by reference.

As used herein the term “transduction medium” refers to an intervening substance through which a transducer imparts vibrations to a vibratory structure of a subject's ear. In some preferred embodiments, the “transduction medium” acts as a bridge to loosely couple a man-made vibrator to a portion of a subject's auditory system that is internal to the tympanic membrane. In some embodiments, the “transduction medium” comprises an artificial or exogenous substance, whereas in other embodiments, the “transduction medium” comprises an autologous substance (e.g., graft recipient is also the donor).

The term “coil” refers to an object made of wire wound in a spiral configuration, used in electronic applications.

The term “magnet” refers to a body (e.g., iron, steel or alloy) having the property of attracting iron and producing a magnetic field external to itself, and when freely suspended, of pointing to the poles.

As used herein, the term “magnetic field” refers to the area surrounding a magnet in which magnetic forces may be detected.

The term “leads” refers to wires covered with an insulator used for conducting current between device components (e.g., receiver to transducer).

The term “housing” refers to the structure encasing or enclosing the magnet and coil components of a transducer. In preferred embodiments, the “housing” is produced from a “biocompatible” material.

As used herein, the term “biocompatible” refers to any substance or compound that has minimal (i.e., no significant difference is seen compared to a control) to no irritant or immunological effect on the surrounding tissue. It is also intended that the term be applied in reference to the substances or compounds utilized in order to minimize or to avoid an immunologic reaction to the housing or other aspects of the invention. Particularly preferred biocompatible materials include, but are not limited to titanium, gold, platinum, sapphire, and ceramics.

As used herein, the term “implantable” refers to any device that may be surgically implanted in a patient. In some preferred embodiments, the device comprises a vibratory unit and a transduction medium that is implanted in a middle ear of a subject. An implanted device is one that has been implanted within a subject, while a device that is “external” to the subject is not implanted within the subject (i.e., the device is located externally to the subject's skin). Similarly, the term “surgically implanting” refers to the medical procedure whereby a hearing device is placed within a living body.

As used herein, the term “hermetically sealed” refers to a device or object that is sealed in a manner such that liquids or gases located outside the device are prevented from entering the interior of the device, to at least some degree. “Completely hermetically sealed” refers to a device or object that is sealed in a manner such that no detectable liquid or gas located outside the device enters the interior of the device. Sealing may be accomplished by any type of suitable method including but not limited to mechanically sealing, gluing, etc. In particularly preferred embodiments, the hermetically sealed device is made so that it is completely leak-proof (i.e., no liquid or gas is allowed to enter the interior of the device at all).

The term “vibrations” refer to limited reciprocating motions of a particle of an elastic body or medium in alternately opposite directions from its position of equilibrium, when that equilibrium has been disturbed.

As used herein, the term “acoustic wave” and “sound wave” refer to a wave that is transmitted through a solid, liquid, and/or gaseous material as a result of the mechanical vibrations of the particles forming the material. The normal mode of wave propagation is longitudinal (i.e., the direction of motion of the particles is parallel to the direction of wave propagation), the wave therefore consists of compressions and rarefactions of the material. It is intended that the present invention encompass waves with various frequencies, although waves falling within the audible range of the human ear (e.g., approximately 20 Hz to 20 kHz) are particularly preferred. Waves with frequencies greater than approximately 20 kHz are “ultrasonic” waves.

As used herein, the term “frequency” (v or f) refers to the number of complete cycles of a periodic quantity occurring in a unit of time. The unit of frequency is the “hertz,” corresponding to the frequency of a periodic phenomenon that has a period of one second. Table 1 below lists various ranges of frequencies that form part of a larger continuous series of frequencies. Internationally agreed radiofrequency bands are shown in this table. Microwave frequencies ranging from VHF to EHF bands (i.e., 0.225 to 100 GHz) are usually subdivided into bands designated by the letters, P, L, S, X, K, Q, V, and W.

TABLE 1
Radiofrequency Bands

| Frequency | | Band | Wavelength |
|---|---|---|---|
| 300 to 30 | GHz | Extremely High Frequency (EHF) | 1 mm to 1 cm |
| 30 to 3 | GHz | Superhigh Frequency (SHF) | 1 cm to 10 cm |
| 3 to 0.3 | GHz | Ultrahigh Frequency (UHF) | 10 cm to 1 m |
| 300 to 30 | MHz | Very High Frequency (VHF) | 1 m to 10 m |
| 30 to 3 | MHz | High Frequency (HF) | 10 m to 100 m |
| 3 to 0.3 | MHz | Medium Frequency (MF) | 100 m to 1000 m |
| 300 to 30 | kHz | Low Frequency (LF) | 1 km to 10 km |
| 30 to 3 | kHz | Very Low Frequency (VLF) | 10 km to 100 km |

The term “modulation” refers to the alteration or modification of one electronic parameter by another. For example, it encompasses the process by which certain characteristics of one wave (the “carrier wave” or “carrier signal”) are modulated or modified in accordance with the characteristic of another wave (the “modulating wave”). The reverse process is “demodulation,” in which an output wave is obtained that has the characteristics of the original modulating wave or signal. Characteristics of the carrier that may be modulated include the amplitude, and phase angle. Modulation by an undesirable signal is referred to as “cross modulation,” while “multiple modulation” is a succession of processes of modulation in which the whole, or part of the modulated wave from one process becomes the modulating wave for the next.

As used herein, the term “demodulator” (“detector”) refers to a circuit, apparatus, or circuit element that demodulates the received signal (i.e., extracts the signal from a carrier, with minimum distortion). “A modulator” is any device that effects modulation.

As used herein, the term “dielectric” refers to a solid, liquid, or gaseous material that can sustain an electric field and act as an insulator (i.e., a material that is used to prevent the loss of electric charge or current from a conductor, insulators have a very high resistance to electric current, so that the current flow through the material is usually negligible).

As used herein, the term “electronic device” refers to a device or object that utilizes the properties of electrons or ions moving in a vacuum, gas, or semiconductor. “Electronic circuitry” refers to the path of electron or ion movement, as well as the direction provided by the device or object to the electrons or ions. A “circuit” or “electronics package” is a combination of a number of electrical devices and conductors that when connected together, form a conducting path to fulfill a desired function, such as amplification, filtering, or oscillation. Any constituent part of the circuit other than the interconnections is referred to as a “circuit element.” A circuit may be comprised of discrete components, or it may be an “integrated circuit.” A circuit is said to be “closed” when it forms a continuous path for current. It is contemplated that any number of devices be included within an electronics package. It is further intended that various components be included in multiple electronics packages that work cooperatively to amplify sound.

The term “piezoelectric effect” refers to the property of certain crystalline or ceramic materials to emit electricity when deformed and to deform when an electric current is passed across them, a mechanism of interconverting electrical and acoustic energy; an ultrasound transducer sends and receives acoustic energy using this effect.

### DETAILED DESCRIPTION OF THE INVENTION

The present invention relates to implantable auditory stimulation systems for imparting vibrations to an inner ear of a hearing impaired subject. In particular, the present invention provides methods and devices for coupling a transducer to a vibratory structure of an ear via a transduction medium.

### I. Prior Devices

Placing a vibratory transducer, or a magnet, or the distal end of a plunger type transducer in direct contact with a vibratory structure of an ear has been the Achilles' heal of implantable auditory systems. The prior art abounds with complicated devices requiring fixed transmitters, bone screws, and/or complicated armatures to couple a vibratory actuation system directly to a vibratory structure. For instance, U.S. Pat. No. 5,360,388 to Spindel et al. (hereby incorporated by reference in its entirety) discloses a method in which a first “normal” auditory pathway (eardrum, ossicles and oval window to the inner ear) is used in conjunction with a second “artificial” auditory pathway comprising a “fixed” transmission means for sending electromagnetic signals to a magnet affixed to a round window. A noteworthy shortcoming of the round window electromagnetic (RWEM) devices of Spindel is the fixation of the transmission means to the skull and the fixation of the vibrational element to the round window of the ear of a hearing impaired subject. Thus, either the transmission means, the magnet means (or transducer means) or both critical components of the hearing device of Spindel must be fixed.

In fact all active products and middle ear direct drive systems approved for use in humans, require securing either the transducer to an ossicle and/or the transmission means to an ear or skull. As summarized below in Table 1, all of the major products require secure fixation of at least one portion of the device directly to a vibratory structure of an ear.

TABLE 1
Prior Art Devices

| Company/ | | |
|---|---|---|
| Institute | Product/Concept | Attachment |
| SoundTec | Direct System: | Dual attachment scheme. |
| | External ear canal hearing aid | Secure transmitter means |
| | with an associated implant. | resides in fixed position in ear |
| | | canal. Secure magnet fixed to |
| | | ossicular chain. |
| Otologics | Met: | Dual attachment scheme. |
| | Partially implantable and | Transducer and associated |
| | totally implantable systems | armature fixed to mastoid |
| | employing a mechanical | bone with screws. Transducer |
| | plunger to drive an ossicular | plunger tip is securely fixed to |
| | chain. | ossicular chain. |
| St. | Envoy: | Dual attachment scheme. |
| Croix | Partially and totally | Transducer and associated |
| Medical | implantable systems | armature fixed to mastoid |
| | employing a mechanical | bone with screws. Transducer |
| | vibrator to drive an ossicular | distal portion of vibrator is |
| | chain or footplate. | securely fixed to ossicular |
| | | chain or footplate. |
| University | RWEM: | Dual attachment scheme. |
| of | Round window | Secure transmitter means |
| Virginia | electromagnetic hearing aid | resides in fixed position |
| | employing a coil to drive a | external to the ear or within |
| | magnet affixed to a round | the skull. Secure magnet |
| | window of an ear. | affixed to round window. |
| Vibrant | Vibrant SOUNDBRIDGE: | Singular attachment scheme. |
| Med-El | Implantable system employing | Floating Mass Transducer is |
| | an inertial drive transducer | affixed to ossicular chain with |
| | attached to an ossicular chain. | titanium clip via a single |
| | | attachment (no associated |
| | | transducer armature is |
| | | required). |
| Implex/ | TICA: | Tri-attachment scheme. |
| Cochlear | Totally implantable cochlear | Microphone securely attached |
| Corp. | amplification system attached | to ear canal for sound input, |
| | to the ear canal, ossicular | plunger transducer firmly |
| | chain and mastoid bone. | fixed to ossicular chain and an |
| | | associated armature fixed to |
| | | the mastoid bone with screws. |

In the field of hearing implants that mechanically drive a vibratory structure of an ear, the focus has been on implementing a system that in addition to promoting hearing meets the following criteria: i) does not impede residual hearing via mass loading or surgical destruction of a hearing structure; ii) is simple to install from a surgical perspective without complicated housings and or armatures; and iii) is reversible or removable. Ironically, the majority of devices in or nearing clinical trials fail in one or more of these areas. The SoundTec device requires disarticulation of the ossicular chain and “hard fixation” of an electromagnetic coil within a deep insertion hearing aid worn in the ear canal. The Otologics Met and the St. Croix devices require multiple fixation points with complicated armatures that either add or have the effect of adding mass to the chain or which remove the chain completely. Likewise, the TICA device has three critical fixation points that require precise micro-placement by a surgeon for the device to function even after the resection of the malleus neck to de-couple the ossicular chain. The Yanagihara device also requires a complicated arrangement and near perfect coupling to the head of the stapes. The currently approved form of the Vibrant SOUNDBRIDGE employs a singular attachment scheme, which may in part explain its popularity. The FMT of the SOUNBRDIGE is presently crimped into a “fixed” position on the incus using a pair of forming forceps.

Obviously, the more complicated the device (e.g., greater number of attachment points requiring precise positioning) and the more hardware associated with the implant, the harder it is to surgically install resulting in increased surgical theater costs and increased patient management issues. This is true for any medical device and any surgical field. Some patient cases, certainly will be more complicated no matter what device or therapy is employed, but the goal for increased adoption and use in a majority of indicated cases calls for simplified approaches, ideally that could be done in a short stay and under a local anesthesia and/or light sedation.

### II. Auditory Stimulation Systems Comprising A Transduction Medium

Devices and methods of the prior art (e.g., Spindel, Adams, Lensinski, Lenhardt, Maniglia, Yanagihara) comprise transmitters and/or transducers that are directly affixed to a vibratory structure of the ear. The implantable hearing systems of the prior art include a transmission means and a transducer means that are both firmly mounted into position to maximize coupling. As determined during development of the present invention, maximization of coupling in such a rigorous way is expected to have one or more disadvantages. For instance, a decrease in residual hearing function is contemplated to occur due to mass loading or impedance changes in the structure and function of the ear. Also surgical complications and/or difficulties are contemplated to arise during implantation. Moreover, directly fixed transmitters or transducers are contemplated to be subject to translocation from static forces and pressure changes to the human ear (e.g., swimming, altitude changes, etc.).

Prior to development of the present invention, devices for improving hearing comprising transmission of a vibrational signal in place of an acoustic signal were based on the premise that the more securely a transducer is secured into position on a vibratory structure of an ear, the better. In contrast, the present invention is based on the non-intuitive finding that the ideal coupling of a transducer to a vibratory structure of an ear is a loose coupling. While the present invention is not limited to any particular mechanism, and understanding of the mechanisms is not necessary to practice the present invention, it is believed that driving a transduction medium that is in contact with both a transducer and an oval window or round window of an ear is contemplated to be akin to driving the fluid of the cochlea directly, without requiring actual physical penetration of the cochlea. Thus the methods and devices of the present invention do not require or even desire direct contact with a vibratory structure. In preferred embodiments, the non-intuitively coupled devices would have zero hard fixation or contact points within the ear. In a subset of these embodiments, the non-intuitively coupled devices would employ a transduction medium that makes contact with multiple vibratory structures of the ear to indirectly drive these structures.

Thus, the auditory stimulation systems of the present invention employ a transducer configured to conduct sound in the form of vibrations to a subject's inner ear through a transduction medium or integration structure. In some preferred embodiments, the transducer is a floating mass transducer (FMT) similar to that of Vibrant Med-El Hearing Technology GmbH of Austria (described in U.S. Pat. Nos. 5,456,654, 5,554,096, 5,624,376, 5,800,336, 5,897,486 and 5,913,815 to Ball et al., all herein incorporated by reference in their entirety) within or adjacent to a transduction medium or integration structure adapted to impart vibrations to an oval window or round window of a subject in response to an electrical signal representing sound waves.

As determined during development of the present invention, it is possible for adequate signal delivery to be achieved via a non-intuitive coupling where the transducer is not in close proximity to a target vibratory structure. In fact, there are significant advantages to having the drive transducer located somewhat remotely from the target vibratory structure. In particular, a remote transducer location permits the use of transducers with larger geometric configurations having larger amplitude and increased frequency range(s). A remote location also allows the employment of more efficient and optimized vibratory transducer designs, heretofore not realizable due to the anatomic constraints of the ear anatomy.

Thus the present invention provides devices and methods in which adequate signal transfer to a cochlea is achieved via indirect methods for mounting a transmitter and/or a transducer. In particular, the present invention provides embodiments that do not require fixing or securely mounting both the transmission means and the transducer body stage into position. Rather the present invention provides devices and methods in which a vibratory transducer is coupled to a vibratory structure of an ear by interposition of a transduction medium such as tissue, collagen, silicone, and the like. Placement of a transducer means within or adjacent to the transduction medium, when the transduction medium is placed in contact with a vibratory structure of an ear, provides a system for delivering a vibratory signal to the cochlea of an ear to promote hearing.

### A. Description of Exemplary Embodiments

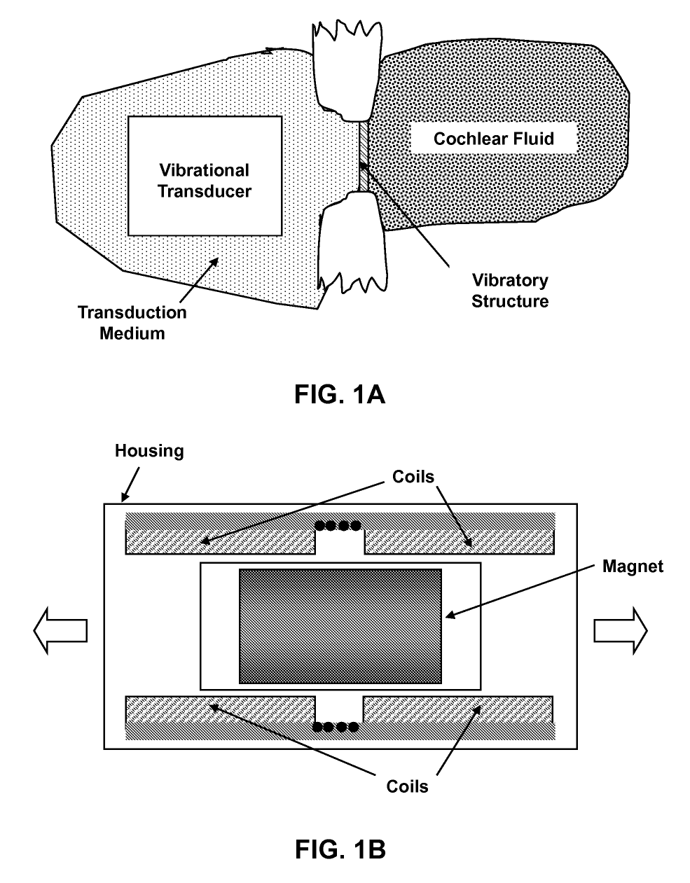

FIG. 1A depicts the functional blocks of preferred embodiments of the present invention comprising a vibrational transducer in contact with a transduction medium that is in contact with a vibratory structure of an ear (e.g., a window, ossicles, bone or tendon). This configuration allows vibrations to be imparted to the cochlea from the vibrational transducer via said transduction medium. Although any type of suitable transduction media could be employed, transduction media that have a viscosity similar to that of the inner ear fluid or of soft tissue are preferred. Other examples include largely aqueous type solution(s) such as saline or liquid silicone that are non-compressible are also suitable. As the transducer is stimulated via electrical input, the resultant vibrations are carried to the cochlea. An alternative interpretation of the arrangement as depicted is that the cochlea fluid has been brought into the middle ear with the oval window or round window acting as a high pass filter. Thus, the non-intuitively coupled transduction systems of the present invention closely approximate stimulation of the fluid of the cochlea directly without penetrating the inner ear space. Non-intuitively coupled transducers as described herein do not require the transducer or any associated armature be “fixed” in position and thus in a sense are “floating.” A potential disadvantage of implantable transducers is their translocation from either large static displacement forces or from blows to the head. Therefore a key to the employment of non-intuitively coupled transducers is to prevent translocation by optimizing the shape of the transduction medium and to encourage epithelial tissue integration of all or part of the vibrational transduction system.

In some embodiments, the non-intuitively coupled transducer is an inertial drive type transducer such as the floating mass transducer (FMT) as shown in FIG. 1B. The Vibrant Med-El SOUNDBRIDGE hearing device currently approved for human use employs a FMT that is 1.5×2.0 mm in diameter. However, both larger and smaller versions of the FMT could be employed in the present invention. Alternative inertial drive transducers include, but are not limited to, piezoelectric (stack, bi-morphs or diaphragm), electromagnetic coil/magnet, electromagnetic coil magnet diaphragm, electrets, MEMS type transducers and magnetostrictors. In preferred embodiments, an electric signal, proportional to sound is delivered to the transducer by a set of input leads, the signal vibrates the transducer and resultant vibrations are transferred to a vibratory structure of an ear via the transduction medium.

In further embodiments, the non-intuitively coupled transducer comprises an electromagnetic coil and a magnet disposed (e.g., embedded) within transduction medium. The closer the electromagnetic coil is to the magnet (or other ferrous material) the more efficient the electronic coupling. The magnet vibrates in response to the audio band electric signal supplied to the coil via a set of leads. Magnet coil geometries of many types could be employed, including standard speaker type electromagnetic driver type configurations. In preferred embodiments, the size of the unit would be limited to the volume of the middle ear space. The coil need not be “fixed” into position and could largely be “floating” and/or suspended in transduction medium along with the magnet. Further vibrational transducer designs suitable for use with the present invention include but are not limited to piezo-electric bi-directional stack transducers, rotational transducers, and torqueing transducers located within or adjacent to a transduction medium.

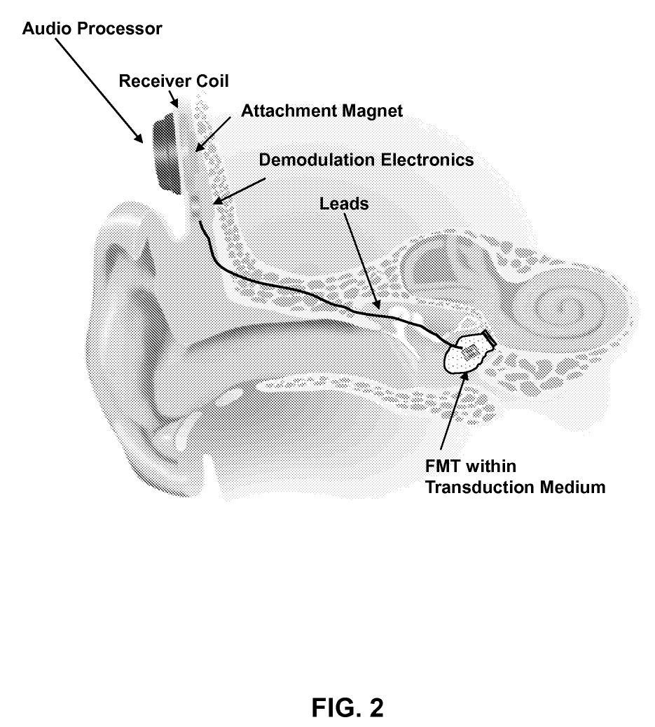

FIG. 2 depicts embodiments of present invention comprising a FMT disposed within a transduction medium to drive a round window of an ear in response to an electrical signal corresponding to sound transmitted through leads. As depicted, a silicon elastomer balloon is filled with a transduction medium such as saline, liquid silicone or sterile water. In preferred embodiments the type of material used as the transduction medium is essentially non-compressible. Non-compressible materials that are largely aqueous in nature are contemplated to be preferred for impedance matching to the inner ear fluid. Alternative materials could also be employed, such as non-liquid silicone elastomer, collagen, lipid soy-bean oil, although the signal delivery to the cochlea may be lower than with transduction medium comprising a non-compressible material. However, adequate stimulation of the cochlea may still be achieved from less than ideal transduction media. In some embodiments, the surface of the transduction medium is pitted, or otherwise architecturally enhanced to promote epithelial tissue growth and/or encapsulation to inhibit transducer translocation. Note that the ossicular chain of the ear shown in FIG. 2 is “intact” and “mobile” so that dual pathways for hearing exist (e.g., a normal acoustic pathway including an ear canal, eardrum, ossicular chain and oval window, and an alternate pathway including an external audio processor, implanted receiver, demodulation electronics, leads, non-intuitively coupled transducer and round window). In the embodiment shown, the distal portion of the transduction medium has a diameter of 1.5 to 2.5 mm with a total surface of 2.25 to 3.5 mm² and a length of 0.5 to 2.5 mm.

The devices and methods of the present invention, however, do not require the presence of a complete normal acoustic pathway. Thus, the devices and methods of the present invention can be employed in subjects whose normal acoustic pathway has been disturbed due to disease, birth defects or trauma (e.g., non-intact middle ear lacking tympanic membrane and/or ossicular chain). In fact, subjects having ears with anatomic malformations are contemplated to receive particular benefit from the non-intuitively coupled transduction systems described herein. These subjects typically receive little to no assistance from traditional acoustic hearing aids, often have impaired cochlea's in terms of dynamic range and sensation level and are frequently poor candidates for otologic reconstructive surgery.

Similarly, the non-intuitively coupled transducer described herein can be employed to treat an ear with single, or multiple fixation points of the ossicular chain and/or footplate. In these subjects the normal acoustic pathway for sound input to the cochlea, though still present, is impaired in function and has limited ability to transmit micro-vibrations to the cochlea. The non-intuitively coupled transducers of the present invention are contemplated to provide adequate stimulation, delivering greater signal than conventional bone conduction implants (e.g., percutaneous, external and implantable). Signal quality is expected to be superior over bone conduction type hearing implants for many patients in this group. In some embodiments, larger versions of the Vibrant Med-El FMT are used in ears with a fixation of the ossicular chain.

In still further embodiments of the present invention, a vibrational transducer is located “outside” of, but in close contact with, the surface of a transduction medium. Preferably, neither the transduction medium nor the transducer is “fixed” into position. In this embodiment very flexible leads are connected to the vibrational transducer. In exemplary embodiments the leads have a gauge of 30 to 50 and are composed of gold or platinum. In further embodiments, the leads are in a “helix” design for greater flexibility. Alternatively, a diaphragm type or “speaker/driver” type transducer is employed, which is in contact with the surface of the transduction medium. Large sound pressure level equivalent signal amplitudes from the surface of the diaphragm are imparted to the transduction medium to the cochlea via a vibratory structure (e.g., window) of an ear.

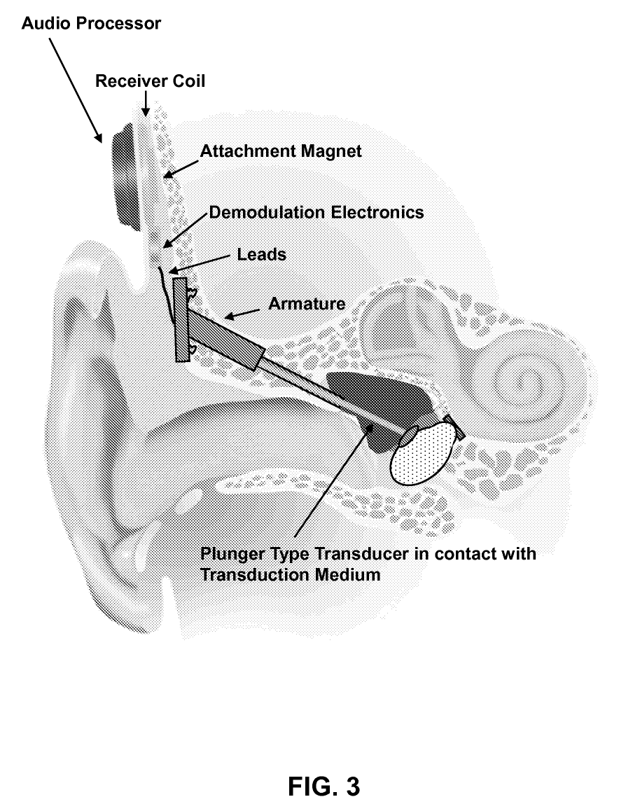

FIG. 3 depicts the use of a plunger-type transducer with a distal excitation point in contact with a transduction medium. A plunger system is typically affixed to the bone via an armature attached to the skull with bone screws. Traditionally the distal end of the plunger-type transducer” is then typically securely fixed to a vibratory structure of an ear. However, in the devices of the present invention, the distal end of the plunger-type transducer does not require a “fixed” attachment point, thereby reducing the total number of attachment points (e.g., only armature bone screws). Limiting the number of “fixed” attachment points is contemplated to improve signal delivery, ease of surgical installation, while reducing feedback via bone conduction, tissue or inter-device pathways. Such plunger type systems include those of St. Croix Medical, Otologics, Rion Corp, Lendhardt Cochlear, and so on and so on.

In a simple form of present invention a silicon elastomer tubing is affixed to one or both distal end(s) of an inertial drive transducer. The tube is filled with a transduction medium comprising a liquid such as silicon, saline, sterile water, lipid soybean oil, or a gel. Alternatively sterile gas is used as a conductive medium. The transduction medium is positioned so that it is in contact with both the transducer and the vibratory structure (e.g., window) of an ear. Use of two cylinders is contemplated to stabilize the unit within the middle ear thereby prevent its translocation. The unit could also be connected to a vibratory structure of an ear at both ends (e.g., between a tympanic membrane and an oval window). In some embodiments, a surgeon trims the tubing during implantation for a custom anatomical fit.

In further embodiments, a transduction medium in the form of a pad, disc or lens is positioned on one end of an inertial drive transducer (e.g., FMT) in order to encourage epithelial cell encapsulation of the coupling to a vibratory structure of an ear. Such pads may be made from silicone elastomer, collagen, Gore-Tex, gold, titanium, and the like. In some embodiments, the pad is very thin and when constructed of a hard material is designed to flex. Alternatively, the transduction medium can be formed as a goblet shaped post with one end of the post in contact with either an oval window or round window of an ear and the other end in contact with an inertial drive transducer. The end of the post in contact with an oval or round window may be approximately 1.0 mm to 3.0 mm in diameter.

In some embodiments comprising a disc shaped transduction medium, the disc is pitted or otherwise architecturally designed to facilitate tissue growth. In particular, the introduction of holes and or pits is contemplated to promote post-surgical tissue remodeling to adhere the transduction medium to a vibratory structure of an ear to minimize transducer translocation. In still further embodiments, the transduction medium is in a “mesh type” configuration. Mesh type designs are contemplated to encourage tissue integration. Additionally, mesh type designs are expected to be “very flexible” for greater surgical ease but with high mechanical impedance to micro-vibratory signal(s) from a portion of the normal acoustic pathway of the ear.

In further exemplary embodiments, the transduction medium is shaped to reside within a middle ear space in order to facilitate adequate positioning of the transducer and to reduce translocation. Customization of the transduction medium shape to an individual patient is contemplated to be possible prior to or during surgical implantation. Thus, such transduction media geometries comprising a transmitter, a coil and a magnet do not require a fixed attachment point. In some embodiments, the transduction medium is configured to substantially fill a middle ear while in others the transduction medium is configured to minimally encapsulate a FMT or coil and magnet (e.g., shaped mesh or fabric wrapped transducer). In still further embodiments, the transduction medium is shaped to contact a portion of an ossicular chain as well as an oval window. A multitude of shapes and a large variety of biocompatible materials are contemplated to be suitable for use as a transduction medium. For instance, resorbable mesh or sheets is contemplated to be advantageous for establishment of a tissue-like architecture. In further embodiments, a shaped collagen or GORE-TEX material encasing a transducer is embedded with a medicament to promote cell growth in the area of the implant.

Additionally, the transduction medium can comprise a tab adjacent to the transducer-encapsulated portion, for use as an osteo-integrating surface (e.g., titanium pitted or coated material). The tab design permits vibration yet inhibits translocation. Thus the tab design is contemplated to facilitate implant integration while obviating the need for bone screws or other hard metal to bone interface.

Alternatively, the transduction medium can be configured as a cage-type structure affixed to one or both ends of a transducer, or wholly enclosing a transducer. Cage-type structures are contemplated to offer structural support, while encouraging post-surgical tissue encapsulation. Likewise, the transduction medium can comprise multiple filaments.

In still further embodiments, the transduction medium is shaped with a ribbed, accordion-type design. This design is contemplated to be particularly beneficial when the transduction medium comprises a gas. Such transduction medium configurations could be used to acoustically as well as vibrationally drive the middle ear space and or inner ear windows. Again, hard fixation to bone would not be required since the transduction medium would assume this function.

### B. Exemplary Benefits of the Present Invention

The advantage of all the tightly fixed devices is believed to be in improved coupling of vibratory energy to the hearing structure(s) of the ear. The present invention is not based on this premise and instead employs a strategy that obviates the need for complicated precision armatures, bone screws, cement(s) or even ossicular chain crimps. In its simplest form, the non-intuitively coupled transducers of the present invention comprise a vibrational transducer with a transduction medium coating to impart vibrations to the cochlear fluid of a subject's ear. In some preferred embodiments, the transduction medium is a liquid or gel substance applied to an FMT or similar transducer, which does not require re-application. The present invention is based, in part, on the surprising finding that an FMT (or similar device) positioned in water in an ear canal is able to drive the middle ear to impart vibrations to the cochlea. Other largely aqueous materials such as oils, liquid saline, liquid silicon as well as gels and silicon elastomers may be used and may be equivalent or superior to water as a transduction medium. Moreover, placement of a transducer in a middle ear and in particular in close contact to an inner ear is contemplated to be superior to placement of a transducer in an external ear. In some embodiments, the non-intuitively coupled transducers of the present invention are configured to promote epithelia cell growth and tissue encapsulation to minimize transducer translocation. Additionally, in contrast to published literature, the direction of the transducer motion is less important when a transduction medium is employed. Consequently when the position and/or direction of the transducer's primary actuation are less important, rotational and torqueing transducers could be employed in combination with a transduction medium.

In certain embodiments, the non-intuitively coupled transducers of the present invention offer the following improvements over the prior art: 1) reduction of multiple or single fixed surgical attachment points (e.g., one to several versus zero hard fixation points); 2) obviation of the need for precision hardware, armatures, crimping, titanium clips, bone screws, ear canal housings and fixed transmission means; 3) reduction of potential negative effect of implantation on residual hearing by obviation of surgical manipulation of the ossicular chain; 4) greater ease in surgical implantation; 5) improved signal delivery permitted with the use of larger transducers; 6) elimination of the requirement of an active ossicular chain or tympanic membrane, and thus can be used by subjects with a fixed ossicular chain, an absent ossicular chain, or other significant ear malformations; and 7) improved long term safety prospects since the maximal vibration requirement for 120 dB is below the distance between a transducer and a vibratory structure.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention, which are obvious to those skilled in the relevant fields are intended to be within the scope of the following claims.

We claim:

1. A system comprising:
a) a transduction medium configured to be positioned within a middle ear of a subject; and
b) a transducer configured to be positioned within, or against said transduction medium such that vibrations from said transducer are able to pass through said transduction medium to vibrate an inner ear of said subject.

2. The system of claim 1, wherein said transducer is an electromagnetic transducer.

3. The system of claim 2, wherein said electromagnetic transducer is a floating mass transducer.

4. The system of claim 1, wherein said transducer is a piezoelectric transducer.

5. The system of claim 1, wherein said transduction medium comprises a silicon elastomer configured to be interposed between said transducer and a vibratory structure of said subject's ear.

6. The system of claim 1, wherein said transduction medium comprises a collagenous material configured to be interposed between said transducer means and a vibratory structure of said subject's ear.

7. The system of claim 1, wherein said transduction medium comprises a biocompatible material configured to be interposed between said transducer means and a vibratory structure of said subject's ear and to encourage tissue encapsulation upon implantation.

8. The system of claim 7, wherein said biocompatible material comprises one or more of the group consisting of hydroxyapatite, titanium, ceravitol, TEFLON and GORE-TEX.

9. The system of claim 1, wherein said transducer is wholly disposed within said transduction medium.

10. The system of claim 1, wherein said transducer is against said transduction medium.

11. The system of claim 1, wherein said transduction medium is cylindrical having a distal end configured to contact a round window or an oval window of said subject's ear and a proximal end configured to contact said transducer.

12. The system of claim 1, further comprising a receiver unit for conducting an electrical signal produced in response to sound, to said transducer.

13. The system of claim 12, wherein said receiver unit is an implantable receiver unit configured to be placed at a subcutaneous position behind said subject's ear.

14. The system of claim 12, further comprising an external audio processor unit suitable for converting sound into an electric signal.

15. The system of claim 14, wherein said external audio processor unit is configured to be magnetically affixed to skin of said subject in a position above said implantable receiver unit.

16. A method for enhancing hearing by artificially vibrating a cochlea of a subject, comprising:
a) placing a vibratory unit comprising a transducer and transduction medium in a middle ear of the subject such that said transducer is positioned within or against said transduction medium;
b) vibrating the cochlea of said subject by imparting vibrations from said transducer through said transduction medium in response to an electrical signal corresponding to sound.

17. The method of claim 16, wherein the transduction medium but not the transducer directly contacts a vibratory structure of the subject's ear.

18. The method of claim 16, wherein a transmitter communicates said electrical signal to said transducer, and wherein both said transmitter and said transducer are in contact within a common transduction medium.

19. The method of claim 18, wherein both said transmitter and said transducer are encapsulated in said transduction medium.

20. The method of claim 17, wherein said vibratory structure is one or both of a round window and an oval window.
